(19) United States
(12) Patent Application Publication
(10) Pub. No.: US 2024/0390925 A1
(43) Pub. Date: Nov. 28, 2024

(54) CONTROLLING SPOT SPRAYING OF AGROCHEMICALS

(71) Applicant: ECOROBOTIX SA, Yverdon-les-Bains (CH)

(72) Inventors: Steve TANNER, Yverdon-les-Bains (CH); Florent DEFAY, Yverdon-les-Bains (CH)

(21) Appl. No.: 18/678,552

(22) Filed: May 30, 2024

Related U.S. Application Data
(63) Continuation of application No. PCT/EP2024/063984, filed on May 21, 2024.

(30) Foreign Application Priority Data
May 25, 2023 (GB) 2307828.0

(51) Int. Cl. B05B 12/12; A01C 21/00; A01M 7/00

(52) U.S. Cl. CPC B05B 12/124; A01C 21/007; A01M 7/0089

(57) ABSTRACT

Described herein is a method of operation of a control system for spraying agrochemicals using a spray assembly. The method comprises defining a position of a first spot spray based on a position of a leading edge of a target object and then defining an initial position in terms of a transverse offset and a longitudinal offset relative to the first spot spray, of at least one new adjacent spot spray such that the combined dose of the first and new spot sprays forms a continuous spray zone that covers a portion of the target object. A two-dimensional dose map resulting from the first and new spot sprays is then determined and used to identify whether pre-defined dose criteria are met. If they are not met, the method comprises adjusting the offsets of the at least one new adjacent spot spray to optimise a received dose.

### CROSS-REFERENCE

This application is a continuation of PCT International Application PCT/EP2024/063984 filed May 21, 2024, which claims the benefit of GB Application No. 2307828.0 filed May 25, 2023, each of which applications is incorporated herein by reference in its entirety.

### TECHNICAL FIELD

The present invention relates to control of spray apparatus for spot spraying of plants with agrochemicals.

### BACKGROUND

Agrochemicals, whether to promote growth (e.g. fertilisers), inhibit growth (e.g. herbicides) or prevent diseases or plagues (fungicides, insecticides, etc.), are typically applied to plants in liquid form using spraying. The agrochemicals are sprayed through nozzles which may be mounted on a spray bar. The spray bar may be mounted on a vehicle (e.g. a tractor or robot) or mounted on a device that is towed by a vehicle. Continuous spraying involves spraying agrochemicals everywhere and the nozzles are in continuous operation. In contrast, spot spraying applies droplets of liquids on specific and predetermined locations through the use of valves (e.g. electromechanically controlled valves) which can switch the flow of the agrochemical on and off rapidly.

Use of continuous spraying is often inefficient since the agrochemicals are sprayed where they are not needed (e.g. onto bare soil) and as well as increasing costs, this increases chemical residues in the soils which can have various impacts including damaging biodiversity and an increased likelihood of phytotoxicity for the sprayed crop plants leading to yield losses. Spot spraying can significantly reduce the amount of agrochemical that is applied. This increases efficiency (since the agrochemical is only applied where it is needed), reduces the environmental impact (e.g. less chemical residues in soils and water, reduced carbon emissions due to reduced fabrication and transport of liquid agrochemicals), reduces use of water, and improves yield.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Described herein is a method of operation of a control system for spraying agrochemicals using a spray assembly. The method comprises defining a position of a first spot spray based on a position of a leading edge of a target object and then defining an initial position in terms of a transverse offset and a longitudinal offset relative to the first spot spray, of at least one new adjacent spot spray such that the combined dose of the first and new spot sprays forms a continuous spray zone that covers a portion of the target object. A two-dimensional dose map resulting from the first and new spot sprays is then determined and used to identify whether pre-defined dose criteria are met. If they are not met, the method comprises adjusting the offsets of the at least one new adjacent spot spray to optimise a received dose. Control signals for the array of nozzles are generated according to the position of the first spot spray and adjusted offsets of the at least one new adjacent spot spray and are output to the spray assembly.

A first aspect provides a method of operation of a spot spray control system for spraying agrochemicals using a spray assembly, the spray assembly comprising an array of nozzles and the method comprising: (i) defining a position of a first spot spray based on a position of a leading edge of a target object; (ii) defining an initial position in terms of a transverse offset and a longitudinal offset relative to the first spot spray, of at least one new adjacent spot spray such that the combined dose of the first and new spot sprays forms a continuous spray zone that covers a portion of the target object, wherein each of the first and new spot sprays is defined by a non-homogenous two-dimensional liquid spatial distribution and the transverse offset is a multiple of an effective spacing of the nozzles in the array of nozzles; (iii) determining a two-dimensional dose map resulting from the first and new spot sprays; (iv) in response to determining, from the two-dimensional dose map, that pre-defined dose criteria are not met, adjusting the offsets of the at least one new adjacent spot spray to optimise a received dose; (v) generating control signals for the array of nozzles according to the position of the first spot spray and adjusted offsets of the at least one new adjacent spot spray; and (vi) outputting the control signals to the spray assembly.

The method may further comprise: in response to determining, from the two-dimensional dose map, that the target object is not fully covered by the spray zone, repeating steps (ii)-(iv) until the target object is fully covered.

Defining an initial position in terms of a transverse offset and a longitudinal offset relative to the first spot spray, of at least one new adjacent spot spray may comprise: defining an initial position in terms of a transverse offset and a longitudinal offset relative to the first spot spray, of three new adjacent spot sprays; and adjusting the offsets of the at least one new adjacent spot spray to optimise a received dose comprises: adjusting the offsets of the three new adjacent spot sprays to optimise a received dose within a quadrilateral defined by the first spot spray and the three new adjacent spot sprays. The method may further comprise: in response to determining, from the two-dimensional dose map, that the target object is not fully covered by the spray zone, placing additional spot sprays using the adjusted offsets until the target object is fully covered.

The two-dimensional liquid spatial distribution for a spot spray may be determined based on a static two-dimensional liquid spatial distribution for a nozzle and received motion data for the spray assembly.

The two-dimensional liquid spatial distribution for a spot spray may be determined based on a static two-dimensional liquid spatial distribution for a nozzle and a detected distance between the array of nozzles and the target object.

The two-dimensional liquid spatial distribution for a spot spray may be determined based on a static two-dimensional liquid spatial distribution for a nozzle and an opening duration of the nozzle.

The two-dimensional liquid spatial distribution for a spot spray may be defined in a look-up table.

The two-dimensional liquid spatial distribution for a spot spray may be defined using a Gaussian or normal distribution.

The method may further comprise: adjusting an opening duration of a nozzle to maintain a constant two-dimensional liquid spatial distribution for a spot spray in response to changes in forward speed of the nozzle during spraying.

Optimizing a received dose may comprise ensuring that the received dose exceeds a pre-defined minimum dose.

The method may further comprise: adjusting the pre-defined minimum dose based on a size or type of the target object.

Optimizing a received dose may comprise ensuring that the received dose does not exceed a pre-defined maximum dose.

A second aspect provides a spot spray control system for spraying agrochemicals using a spray assembly, the spray assembly comprising an array of nozzles and the spot spray control system comprising: a processor; one or more interfaces configured to receive target object data and output control signals to the spray assembly; and memory arranged to store a computer program which, when executed by the processor, causes the control system to: (i) define a position of a first spot spray based on a position of a leading edge of a target object; (ii) define an initial position in terms of a transverse offset and a longitudinal offset relative to the first spot spray, of at least one new adjacent spot spray such that the combined dose of the first and new spot sprays forms a continuous spray zone that covers a portion of the target object, wherein each of the first and new spot sprays is defined by a non-homogenous two-dimensional liquid spatial distribution and the transverse offset is a multiple of an effective spacing of the nozzles in the array of nozzles; (iii) determine a two-dimensional dose map resulting from the first and new spot sprays; (iv) in response to determining, from the two-dimensional dose map, that pre-defined dose criteria are not met, adjust the offsets of the at least one new adjacent spot spray to optimise a received dose; (v) generate control signals for the array of nozzles according to the position of the first spot spray and adjusted offsets of the at least one new adjacent spot spray; and (vi) output the control signals to the spray assembly via the one or more interfaces.

A third aspect provides a method of operation of a spot spray control system for spraying agrochemicals using a spray assembly, the spray assembly comprising an array of nozzles and the method comprising: determining, using pre-calculated tables, a longitudinal offset of a first spot spray, transverse and longitudinal offsets for one or more new adjacent spot sprays, and a nozzle opening duration of each spot spray, wherein each of the first and new spot sprays is defined by a non-homogenous two-dimensional liquid spatial distribution and the transverse offset is a multiple of an effective spacing of the nozzles in the array of nozzles; defining a position of the first spot spray based on a position of a leading edge of a target object and the determined longitudinal offset of the first spot spray; defining positions of the one or more new adjacent spot sprays relative to the position of the first spot spray based on the determined transverse and longitudinal offsets for the one or more new adjacent spot sprays; generating control signals for the array of nozzles according to the position of the first spot spray and the one or more new adjacent spot sprays, the opening duration for each spot spray and a displacement speed of the nozzles; and outputting the control signals to the spray assembly.

Determining, using pre-calculated tables, a longitudinal offset of a first spot spray, transverse and longitudinal offsets for one or more new adjacent spot sprays and a nozzle opening duration for each spot spray may comprise: performing a look up in the pre-calculated tables for the longitudinal offset of the first spot spray, the transverse and longitudinal offsets for one or more new adjacent spot sprays and the nozzle opening duration for each spot spray, wherein the look up is based on a speed of the array of nozzles, a pre-defined minimum dose and an input distance between the nozzles and the target object.

The method may further comprise: in response to determining that the target object is not fully covered by the first and new spot sprays, placing additional spot sprays using the determined transverse and longitudinal offsets until the target object is fully covered.

The method may further comprise: pre-calculating the tables of offsets and nozzle opening durations, the tables comprising a longitudinal offset of a first spot spray, transverse and longitudinal offsets for one or more new adjacent spot sprays, and nozzle opening durations of each spot spray for different values of speed, pre-defined dose, pressure and distance to the target object.

A fourth aspect provides a spot spray control system for spraying agrochemicals using a spray assembly, the spray assembly comprising an array of nozzles and the spot spray control system comprising: a processor; one or more interfaces configured to receive target object data and output control signals to the spray assembly; and memory arranged to store a computer program which, when executed by the processor, causes the control system to: determine, using pre-calculated tables, a longitudinal offset of a first spot spray, transverse and longitudinal offsets for one or more new adjacent spot sprays, and a nozzle opening duration for each spot spray, wherein each of the first and new spot sprays is defined by a non-homogenous two-dimensional liquid spatial distribution and the transverse offset is a multiple of an effective spacing of the nozzles in the array of nozzles; define a position of the first spot spray based on a position of a leading edge of a target object and the determined longitudinal offset of the first spot spray; define positions of the one or more new adjacent spot sprays relative to the position of the first spot spray based on the determined transverse and longitudinal offsets for the one or more new adjacent spot sprays; generate control signals for the array of nozzles according to the position of the first spot spray and the one or more new adjacent spot sprays, the opening duration for each spot spray and a displacement speed of the nozzles; and output the control signals to the spray assembly via the one or more interfaces.

A fifth aspect provides a computer program comprising instructions which, when the program is executed by a computer, cause the computer to carry out any of the methods described above.

A sixth aspect provides a computer-readable medium having stored thereon a computer program comprising instructions which, when the program is executed by a computer, cause the computer to carry out any of the methods described above.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The embodiments described below are not limited to implementations which solve any or all of the disadvantages of known methods of controlling spraying of agrochemicals.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a first example spot spraying system;

FIG. 2 is a schematic diagram of a second example spot spraying system;

FIG. 3 is a schematic diagram of a dual spray bar arrangement;

FIG. 4 shows two different examples of one dimensional (1D) spot dose profiles;

FIG. 5 shows an example shape of a spot spray;

FIG. 6 shows an example representation of a 2D liquid spatial distribution of a nozzle in the form of a look-up table;

FIG. 7 shows a first example method of operation of spot spray control system such as shown in FIG. 1 or FIG. 2;

FIG. 8 shows two examples of a resultant 2D liquid spatial distribution for a spot spray as a result of different opening durations and a forward movement;

FIG. 9 is a graphical representation that shows how adjusting the offsets can be used to optimise the received dose across the target object;

FIG. 10 shows an example implementation of the method of FIG. 7;

FIG. 11 shows an example method of adjusting a minimum dose;

FIG. 12 shows a second example method of operation of spot spray control system such as shown in FIG. 1 or FIG. 2;

FIGS. 13-16 show example implementations of the method of FIG. 12;

FIG. 17 shows a third example method of operation of spot spray control system such as shown in FIG. 1 or FIG. 2; and

FIG. 18 illustrates various components of an example spot spray control system in the form of a computing-based device.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

As described above, spot spraying of agrochemicals can be significantly more efficient than continuous spraying. To be effective, however, spot spraying requires an efficient control system that can translate the target spray area into a set of control signals for the valves associated with the nozzles. Errors in this translation result in a mismatch between the target spray area and the actual spray area and this can reduce efficiency (e.g. where the actual spray area is larger than the target spray area) and effectiveness (e.g. by not spraying parts of the target spray area). In many applications, the target spray area is determined in real-time (e.g. using a camera system that scans an area of a field ahead of the spray bar passing over the area) and so the available time to perform the translation is very short (e.g. less than 500 ms).

An important spray parameter in the application of agrochemicals is the control of the dose per unit area. The highest level of spatial dose homogeneity must be guaranteed. Indeed, if the dose is not sufficient, the efficiency of the chemistry is reduced and may compromise the operation. If too high, the dose can exceed legal limits and be harmful for the environment, and/or cause harm to the crop plants through phytotoxicity.

Known control methods for spraying systems for agrochemicals rely upon each nozzle providing a homogenous application within the spray pattern shape of the nozzle. In the case of a continuous spraying done with an array of nozzles mounted orthogonally to the displacement direction of the application machine, as there is no need to avoid some part of the ground, a good dose homogeneity is obtained by using nozzles with homogeneous lateral distribution profiles, having a relatively large jet divergence angle in the lateral direction (common values are 80 to 110 degrees), and separated laterally with a distance in general smaller than their vertical distance to the target, so that the jets of droplets produced by adjacent nozzles overlap largely together and combine into a dense lateral cloud of droplets distributed homogeneously when they hit the ground.

For the case of a spot spray application, a homogenous application of droplets is much harder to obtain for the following reasons. First, as the area of a single spot spray must be as small as possible to be as spatially selective as possible (e.g. so that agrochemical is applied where it is needed and not on other neighbouring plants), the jet divergence angle of a nozzle must be much smaller than for a continuous spray (typically 15 to 25 degrees), which does not help in equalizing the dose over a large area. Second, the distance from nozzle to target must be as short as possible to guarantee the highest spot placement accuracy. Therefore, overlapping adjacent jets when both nozzle to target distance and jet divergence angle are small is a challenging task, as the resulting required nozzle to nozzle lateral distance becomes very small.

Such a high density of nozzles leads to the need to use low flow nozzles to avoid applying too much product. Low flow nozzles are hard to fabricate and tend to get clogged easily. Third, as the movement of the application machine can be fast (e.g. several meters per second), the opening duration of the electromechanical valves associated with the nozzles must be very short to produce short spots in the forward direction. This sets challenges in the design of the valve. Fourth, the nozzle to target distance can vary during the application due to movement of the spray bar from ground, or ground irregular surface, or difference of heights between targets to be sprayed (e.g. where the plant height varies). Such a varying distance from nozzle to target renders the control of adjacent overlap ratio difficult. When the overlap ratio is not well controlled, it is difficult to base upon a specific nozzle lateral dose profile to get homogeneity through overlapping, as this overlapping can rapidly change from 2 jets overlapping to 3 jets overlapping, for instance, when the vertical distance increases.

All these elements render the application of a homogeneous dose difficult on spot spraying, both for single spot sprays (i.e. when a single nozzle is activated) or for larger spot sprays resulting in the cumulative action of several neighboring nozzles. Nevertheless, dose control remains a significant concern in spot spray devices. Therefore, there is a strong need to develop methods that enable control of the dose in spot spray equipment characterized by dense nozzle arrays with small jet divergence angles and small nozzle to target distances (typically 20 to 30 cm).

Described herein are improved methods of controlling spot spraying of agrochemicals that take into account the non-homogeneity of the two-dimensional (2D) liquid spatial distribution of a nozzle. This 2D non-homogenous liquid spatial distribution is used in a control algorithm to define a spray zone based on a detected target object (e.g. a plant), calculate a resultant dose map and then refine the spray zone based on pre-defined target dose parameters such as a minimum, maximum or average required dose. Control signals are generated for an array of nozzles in a spray assembly based on the refined spray zone and output to the spray assembly.

The agrochemicals sprayed using the methods described herein may have any of the purposes found in plant protection or plant fertilization and so the plant that is the detected target object, or which may form part of the detected target object where the target object is a cluster of plants, may be a crop or a weed.

By using the methods described herein, the efficiency and adaptability of the spot spraying is increased. By precise control of the agrochemicals delivered to the target object, the overall amount of agrochemicals sprayed can be reduced, thereby improving efficiency and effectiveness and reducing the environmental impact of both the use of the agrochemicals and their fabrication and transport. As described below, the method can adapt to changes in the spray assembly and the topology of the surface being sprayed in real-time (e.g. in the time between detection of a target object and a nozzle passing over that target object), rather than requiring precise control of the spray height (i.e. the separation of nozzle and the target object).

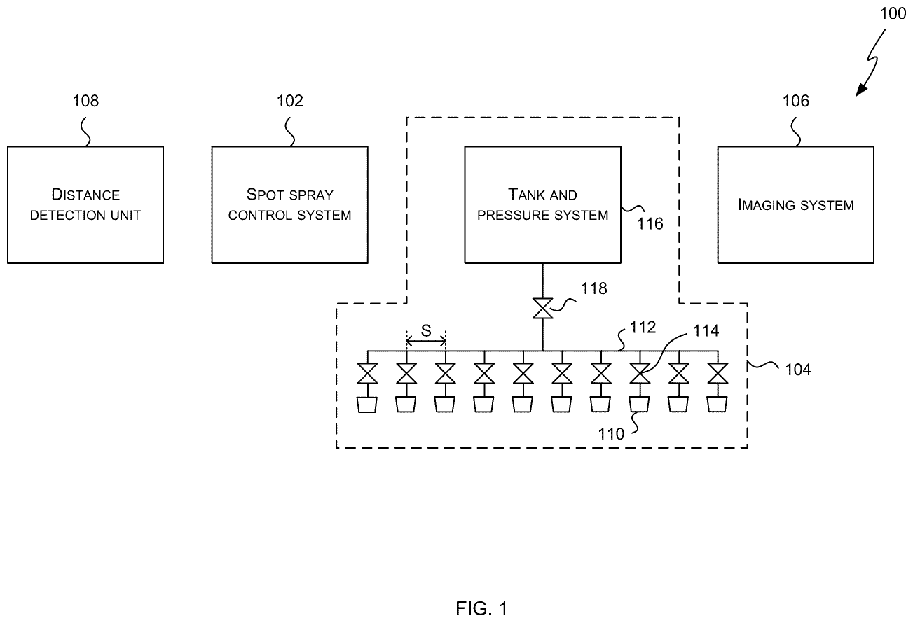

FIG. 1 shows a schematic diagram of a first example spot spraying system 100. The system 100 comprises a spot spray control system 102, a spray assembly 104, an imaging system 106 and a distance detection unit 108. It will be appreciated that the spot spraying system 100 may comprise other elements not shown in FIG. 1, such as one or more sensors (e.g. an accelerometer, a GPS receiver, a sensor, etc.).

The spray assembly 104 comprises a plurality of nozzles 110 mounted on a spray bar 112. The nozzles 110 are mounted at a regular spacing, s, along the spray bar 112. Each nozzle 110 has an associated electromechanical valve 114 that is positioned between the nozzle 110 and the spray bar 112. These electromechanical valves 114 can be switched on and off rapidly and precisely to control the flow of fluid from each nozzle 110 and generate each spot spray. A spot spray refers to the fluid output from a nozzle 110 in a single valve opening (i.e. between the valve opening and subsequently closing again). The time that the valve 114 is open and generating a single spot spray may be referred to as a spot duration or opening duration, t, and may be in the region of 3-20 ms. The spray bar 112 is in fluid communication with a tank and pressure system 116 via an optional inlet electromechanical valve 118. The tank and pressure system 116 comprises a tank for holding the agrochemical that is to be sprayed and a pressure system that generates and controls the pressure, p, at which the agrochemical is supplied from the tank to the spray bar 112 and ultimately to the nozzles 110. The volume of fluid output in a single spot spray is a function of the opening duration, the nozzle design (e.g. nozzle diameter) and the pressure and the area that the single spot spray covers (and hence the dose per unit area) is also dependent upon the distance between the nozzle and the surface (e.g. the ground). The inlet valve 118 enables the tank and pressure system 116 to be isolated from the spray bar 112, e.g. for maintenance purposes.

It will be appreciated that the spray assembly 104 may differ from that shown in FIG. 1. For example, the valves 114 may be integrated into the spray bar 112, there may be more than one spray bar 112 and/or the inlet valve 118 may be omitted.

The imaging system 106 scans a portion of a field ahead of the spray bar 112 passing over the area and identifies target objects for spraying. As described above, depending upon the type of agrochemical being sprayed, the target object may be a desired plant (i.e. a crop) or an undesired plant (i.e. a weed). The imaging system 106 may comprise one or more cameras and/or other sensors and a processing system arranged to process the data captured by the cameras and/or other sensors and output data defining a target object to be sprayed.

The distance detection unit 108 determines, for one or more points (e.g. each point of the ground), a distance between the spray bar 112 and the target object (i.e. the highest part of the plant to be sprayed). For many applications, the agrochemical is sprayed, by the nozzles 110, substantially vertically downwards and the distance determined by the distance detection unit 108 is a vertical height. In other spraying orientations (e.g. spraying a substantially vertical surface), the distance detection unit 108 still determines a distance between the spray bar 112 and the target object but this may, for example, be in a vertical plane. Any suitable technology may be used to perform distance detection (e.g. height detection) and in an example, the distance detection unit 108 may comprise 3D depth sensors or distance range sensors. The distance detection unit 108 may determine a single distance for the entire spray bar (e.g. the minimum distance between the spray bar and the target objects that are underneath the spray bar) or more granular distance data may be determined, e.g. per group of adjacent nozzles, per nozzle or even finer.

The spot spray control system 102 generates control signals for the valves 114 associated with the nozzles 110 in the spray assembly 104 based on input received from the imaging system 106 and optionally based on input received from the distance detection unit 108. The spot spray control system 102 performs the improved methods of controlling spot spraying of agrochemicals described herein and these are described in more detail below.

Whilst the distance detection unit 108, imaging system 106 and spot spray control system 102 are shown as separate elements in FIG. 1, it will be appreciated that some or all of them may share common components (e.g. the distance detection unit 108 and imaging system 106 may share sensors and any or all of them may share processing capabilities) or two or more of the distance detection unit 108, imaging system 106 and spot spray control system 102 may be combined.

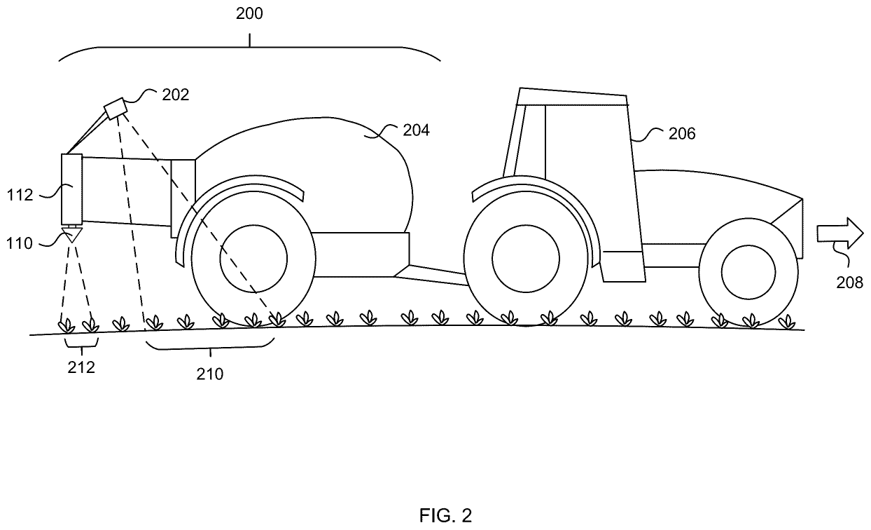

FIG. 2 shows a schematic diagram of a second example spot spraying system 200. The system 200, like that shown in FIG. 1, comprises a spot spray control system, a spray assembly, an imaging system and a distance detection unit, although only some elements of these are visible in FIG. 2. In particular, FIG. 2 shows the nozzles 110 and spray bar 112 as well as a camera 202 that is part of the imaging system. The tank and pressure system, the spot spray control system and other parts of the imaging system may be located within the body 204 of the spot spraying system 200. In this example, the spot spraying system 200 is towed behind a vehicle 206 (e.g. a tractor) and the direction of travel of the vehicle, when moving forwards, is marked by an arrow 208. As shown in FIG. 2, the imaging system scans a portion of a field 210 ahead of (i.e. before) the spray bar 112 passing over the area, i.e. the area being sprayed 212 is behind the area being scanned 210. As the distance between the scanned portion of the field 210 and the area being sprayed 212 is fixed, the time delay between the scanning of the field and the spray bar passing over the area can be calculated if the forward speed of the vehicle 206 is known. This is taken into consideration when generating control signals for the mechanical valves 114 in order to spatially synchronize the spot sprays and the target objects.

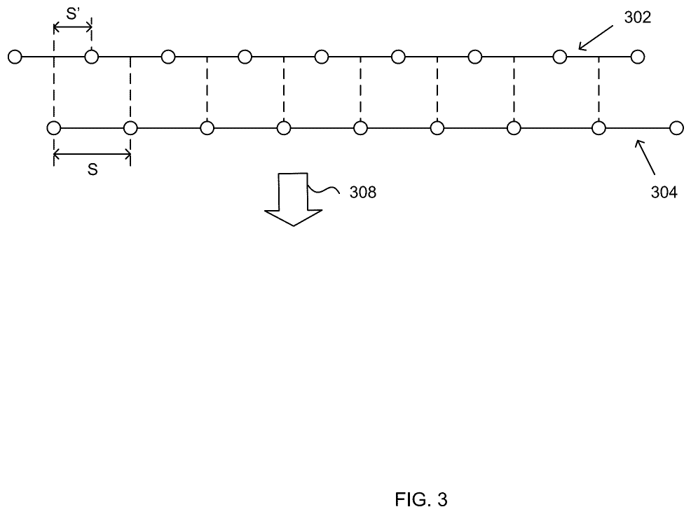

The spray assemblies shown in the systems 100, 200 in FIGS. 1 and 2 each comprise a single spray bar 112 with nozzles 110 mounted at a regular spacing, s, along the spray bar 112. In some example systems, the spray assemblies may comprise a plurality of spray bars with the nozzles on different spray bars offset from each other. In the example shown in FIG. 3, each of the spray bars 302, 304 has nozzles mounted at a regular spacing, s, but the nozzles are offset between the spray bars giving an effective nozzle spacing of the overall spray assembly of s′=s/2. The effective nozzle spacing may be further reduced by having more than two spray bars, e.g. s/3 for three spray bars, s/4 for four spray bars, etc. The spray bars are oriented perpendicular to the direction of travel of the system so that where there are a plurality of spray bars in a spray assembly, these are spaced from each other in the direction of travel which is indicated by arrow 308 in FIG. 3. The control methods described herein may be used with any arrangement of spray bars and nozzles. Of course, when valve control signals are directed to several bars in parallel, the control signals of the second or following bars must be delayed accordingly with the forward speed of the bars so that the spray spots of all bars are disposed on a same lateral line on the ground.

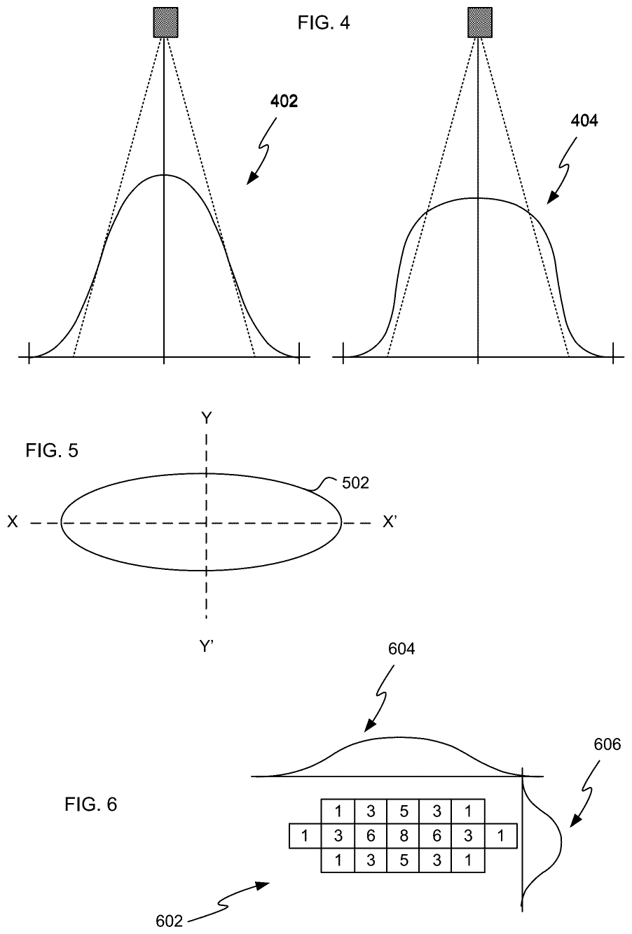

The static 2D liquid spatial distribution of a nozzle may be mathematically defined, e.g. in terms of parameters that define one or more equations, such as a Gaussian or normal distribution, that correspond to the distribution in 2D. FIG. 4 shows two different examples of one dimensional (1D) spot dose profiles 402, 404. These 1D profiles 402, 404 may represent the dose profile taken along a line through an elliptical spot spray 502 as shown in FIG. 5, e.g. along the line X-X′ or the line Y-Y′. In other examples, the static 2D liquid spatial distribution of a nozzle that is input to the method may be input in the form of a pre-calculated look-up table. For example, the look-up table may sub-divide the 2D spatial distribution into a 2D grid of cells and specify the dose received within each cell, as shown in the example 602 in FIG. 6. As well as showing an example look-up table 602, FIG. 6 also shows the equivalent 1D distributions 604, 606 along two perpendicular lines passing through the centre of the spot spray (e.g. along the equivalent of lines X-X′ and Y-Y′ shown in FIG. 5).

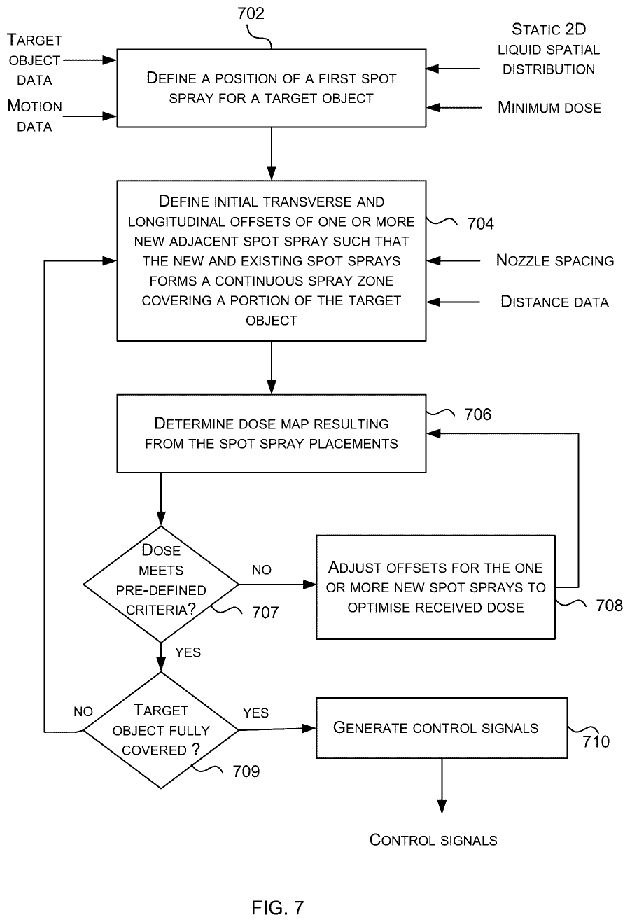

FIG. 7 shows a first example method of operation of spot spray control system, such as the spot spray control system 102 shown in FIG. 1. As shown in FIG. 7, the method comprises defining a position of a first spot spray based on a position of a leading edge of a target object (block 702) and then defining the initial position, relative to the first spot spray, of one or more new adjacent spot spray such that the new and existing spot sprays form a continuous spray zone covering at least a portion of the target object (block 704). The position of the first spot spray may be defined so that the leading edge of the target object receives at least a pre-defined minimum dose, where this pre-defined minimum dose may be fixed or variable and various examples it may be received as an input to the method. As described above, the target object is a plant or group of plants that are to be sprayed, by the spot spray control system, with agrochemicals. The leading edge of the target object corresponds to the first point of the target object to enter within the area being scanned 210 and hence the first point of the target object to pass under the spray bar.

The initial positions of the one or more new adjacent spot sprays are defined in terms of initial transverse and longitudinal offsets from the first spot spray. The transverse offsets (which may also be referred to as lateral offsets) are along an axis perpendicular to the direction of travel of the system (and hence parallel to the spray bar) and each transverse offset is a multiple of the nozzle spacing, or effective nozzle spacing where the spray system comprises a plurality of spray bars (e.g. as shown in FIG. 3). The longitudinal offsets are along a direction parallel to the direction of travel of the system and each longitudinal offset corresponds to a duration of motion of the spray assembly at a known speed. This speed which corresponds to a speed over the surface on which the target object is located may be referred to as the displacement speed or forward speed to distinguish it from the speed at which a nozzle is turned on and off by controlling the corresponding electromechanical valve. A transverse offset defines which nozzle on a spray bar is used (and hence which electromechanical valve is switched on and off), whereas a longitudinal offset defines the temporal spacing of the spot sprays and hence the control signals. The transverse and longitudinal offsets of the first set of one or more new adjacent spot sprays (as placed in a first iteration of block 704) are defined relative to the position of the first spot spray, whereas the transverse and longitudinal offsets of any subsequent sets of one or more new adjacent spot sprays (as added in subsequent iterations of the method of FIG. 7) may be defined relative to the position of the first spot spray or to an immediately preceding adjacent spot spray.

As described above, the initial transverse and longitudinal offsets are defined (in block 704) such that the first spot spray and the one or more new adjacent spot sprays overlap to form a continuous spray zone that covers at least a portion of the target object. For small target objects, the spray zone formed by the first spot spray and first set of one or more new adjacent spot sprays may cover the entire target object, but for larger target objects, the spray zone may not cover the entire target and hence may only cover a portion of the target object.

Having determined the position of a first spot spray (in block 702) and an initial placement for one or more new adjacent spot sprays (in block 704), the method proceeds to determine (e.g. calculate) a 2D dose map from the combination of new and existing spot sprays and to use the dose may to determine whether to adjust the position of the one or more new adjacent spot sprays (in block 707) and whether to add more new adjacent spot sprays (709). The determination of the 2D dose map (in block 706) comprises calculating the combined dose of the spots.

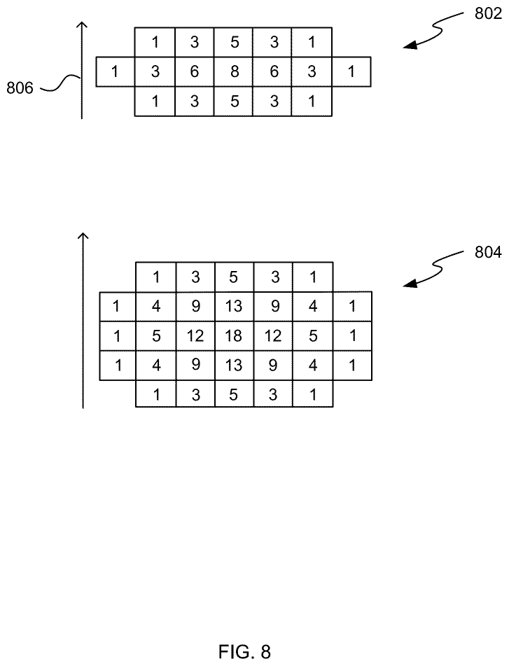

The combined dose of the spot sprays is the dose of agrochemicals resulting from the first spot spray (the position of which is defined in block 702) and the one or more additional spot sprays (the initial position of which are defined in block 704). As described above, each individual spot spray (i.e. each of the first spot spray and the one or more additional spot sprays) is defined by a non-homogenous 2D liquid spatial distribution, such as shown in FIGS. 4-6, that assumes that the nozzle is static and is dependent upon the nozzle design; however, as the spray assembly is moving, the resultant 2D liquid spatial distribution for any spot spray is a modified version of the static 2D liquid spatial distribution as a result of the motion during the period of time that the valve associated with the nozzle is open. As noted above, the opening duration for a valve may be in the range of 3-20 ms and the speed of the system may be around 2 m/s, resulting in the nozzle moving by around 1-4 cm during the time that the valve is open. FIG. 8 shows two examples of a resultant 2D liquid spatial distribution 802, 804 for a spot spray as a result of different opening durations for a given forward speed of the nozzle. In the first example resultant 2D liquid spatial distribution 802, the opening duration is 5 ms and in the second example resultant 2D liquid spatial distribution 804, the opening duration is 15 ms. The arrow 806 shows the direction of motion of the spray assembly and both the increased dose and increased spreading as a consequence of the increased opening duration are clearly visible in the second example.

When the spray assembly is moving in a direction perpendicular to the spray bar (e.g. forwards) the speed of each nozzle is the same; however, if the motion of the spray assembly includes some rotation (e.g. because a corner is being turned), the speed of the nozzles will differ across a spray bar. Consequently, even if the same static 2D liquid spatial distribution is used for each nozzle, the resultant 2D liquid spatial distribution may differ between nozzles.

As the spreading of the static 2D liquid spatial distribution is dependent upon the translational speed (e.g. forward speed) of the spray assembly, in some examples, the opening duration of the nozzles may be adjusted to compensate for changes in speed (e.g. as determined from the motion data that is input to the method). However, as changing the opening duration modifies the dose, even where this is used, the individual spray spots may have different maximum applied doses. This means that the combined dose of the spot sprays and their arrangement, will vary depending upon the local nozzle speed.

The combined dose corresponds the sum of the resultant 2D liquid spatial distributions for each spot spray, taking into consideration the motion of the spray system. Therefore calculating the combined dose comprises determining the resultant 2D liquid spatial distribution for each spot spray (including taking into consideration characteristics of each nozzle, their speed and their opening duration, where there are differences) and summing the resultant 2D liquid spatial distributions.

As shown in FIG. 7, the static 2D liquid spatial distribution of a nozzle, the nozzle spacing and motion data (e.g. which defines the forward speed of the spray assembly) may be provided as inputs to the method. Alternatively, some or all of them may be fixed (e.g. the method may use a fixed nozzle spacing and/or static 2D liquid spatial distribution, rather than receiving this as an input). Where all the nozzles in a spray assembly are identical, or at least of an identical design, the same static 2D liquid spatial distribution may be used for all nozzles in the spray assembly. Alternatively, where there is more than one type of nozzle within a spray assembly, the static 2D liquid spatial distribution for the nozzle corresponding to the transverse position of the spot spray is used to determine the initial position of the one or more adjacent spot sprays (in block 704) and to calculate the dose map (in block 706). The static 2D liquid spatial distribution may also be dependent upon one or more other parameters such as the particular agrochemical mixture being sprayed, its dilution and the pressure in the tank and pressure system. Different static 2D liquid spatial distributions may be used (e.g. selected and input to the method) dependent upon these parameters or their effects may be included in the calculation of the resultant 2D liquid spatial distribution (e.g. in block 706).

As described above, the static 2D liquid spatial distribution of a nozzle that is input to the method may be mathematically defined (e.g. in terms of a Gaussian or normal distribution) or input in the form of a pre-calculated look-up table. By using a look-up table, the computational complexity of determining the combined dose and dose map is reduced and this may be advantageous since, as described above, the available time for performing this calculation is very short.

Having calculated the dose map (in block 706), the method proceeds to determine whether the dose applied across the target object meets pre-defined criteria (block 707). These pre-defined criteria may, for example, be that the dose applied at each point on the target object exceeds the pre-defined minimum or that the dose applied at each point on the target object is between the pre-defined minimum and a pre-defined maximum. If the pre-defined criteria are not met (‘No’ in block 707), the offsets for the one or more new spot sprays are adjusted to optimise the received dose across the target object (block 708). This optimisation may use the same pre-defined criteria as in block 707 or may use additional or alternative criteria. Example optimization criteria may include one or more of the following: (i) the dose applied at each point on the target object exceeds the pre-defined minimum, (ii) the dose applied at each point on the target object is between the pre-defined minimum and a pre-defined maximum, (iii) the area of the target object that receives at least the pre-defined minimum dose is maximized, (iv) the difference in received dose across the target object is reduced, (v) the received dose across the target object is reduced whilst ensuring that it exceeds the pre-defined minimum at all points on the target object, (vi) the dose at any point of the target object does not exceed a pre-defined maximum dose, and (vii) the overall received dose outside the target object is reduced. As the transverse offset is always a multiple of the nozzle spacing, or effective nozzle spacing, this places a restriction on how the transverse offset can be adjusted whereas there is more flexibility to adjust the longitudinal offset.

The different optimization criteria (i)-(vii) described above provide different benefits. Criteria (i) and (iii) increase the effectivity of the spraying operation. Criteria (ii) and (vi) ensure that legally authorized levels are not exceeded, or that phytotoxicity does not become a concern in the case of applying agrochemicals such as fertilizers on the crop plants. Criteria (iv) provides a more uniform dose. Criteria (v) reduces the volume of agrochemicals used whilst maintaining effectiveness. Criteria (vii) reduces the wastage of agrochemicals and so increases the efficiency of the spot spray operation and reduces any adverse environmental impacts over over-use of agrochemicals. It also reduces the risk of phytotoxicity for a crop plant adjacent to the target object. Criteria (vii) may be important if the target object is a weed and the agrochemical is a herbicide that is not highly selective and hence may affect adjacent crop plants.

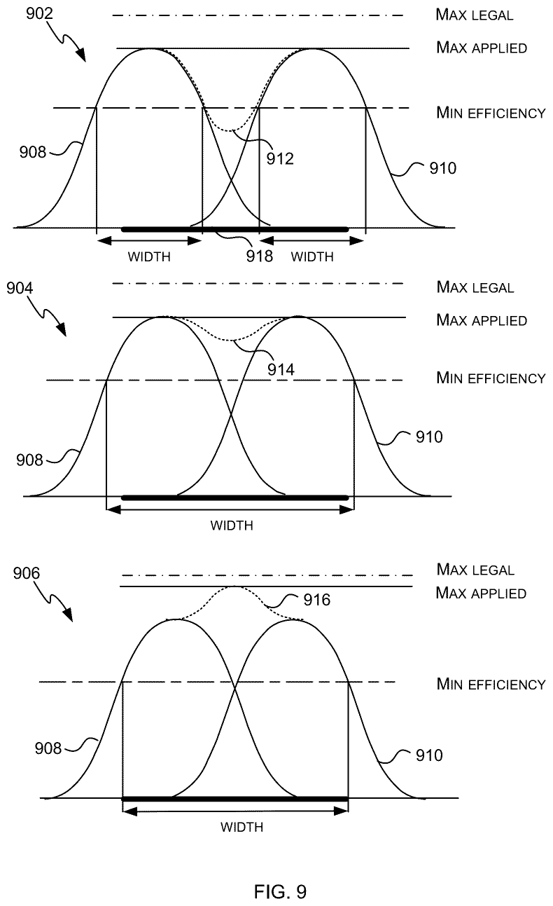

FIG. 9 shows how adjusting the offsets can be used to optimise the received dose across the target object. FIG. 9 shows three examples 902, 904, 906 with different spacings of the same two spot sprays (with individual liquid spatial distributions 908, 910) and in each example the pre-defined minimum (labelled ‘min efficiency’), the maximum applied dose (labelled ‘max applied’) and a pre-defined maximum (labelled ‘max legal’) are shown. Where the two spot sprays overlap, the cumulative dose 912, 914, 916 from the two spot sprays in the overlapping region are also shown as well as the extent 918 of the target object.

The first example 902 shows an initial placement of a first spot spray 908 on the left and a new adjacent spot spray 910 on the right. The two spot sprays are overlapping and so form a continuous spray zone and meet the criteria in block 704; however, the combined dose 912 does not exceed the pre-defined minimum over the entirety of the target object 918. In the second example 904, the offset of the new adjacent spot spray 910 has been reduced so that the spot sprays 908, 910 are closer together. In this second example, the combined dose 914 does exceed the pre-defined minimum over the entirety of the target object 918. In the third example 906, the offset of the new adjacent spot spray 910 has been reduced further so that the spot sprays 908, 910 are closer together than in the second example. In this third example, the combined dose 916 does exceed the pre-defined minimum over the entirety of the target object 918. Whether the second or third example is considered more optimum will depend upon the criteria used. In the second example, the maximum applied is lower so the overall dose within the area of the target object is lower than in the third example; however, the overall dose outside the area of the target object is higher than in the third example.

Once the dose meets the pre-defined criteria (‘Yes’ in block 707), the method determines whether the entirety of the target object is covered by the spray zone (block 709) and if not (‘No’ in block 709), the method is repeated to place another set of one or more new adjacent spot sprays (in block 704) and this positions of these newly placed spot sprays may be adjusted, as described above.

Once the target object, as defined in the input target object data, is fully covered (‘Yes’ in block 709), control signals for the valves associated with the nozzles in the spray assembly are generated, using the adjusted offsets from block 708 (block 710) and output to the spray assembly. These control signals may be in the form of on/off orders for the valves (e.g. state vectors). It will be appreciated that these control signals take into consideration the time taken between the imaging of a point on the field and the spray bar passing over that point (as determined from the motion data), in order to synchronize the spot sprays with the imaged target object. The time taken is a function of the speed of the spray assembly and the distance between the field of view of the imaging system and the spray bar.

By using the method of FIG. 7, the efficiency and adaptability of the spot spraying is increased. By more careful control of the agrochemicals delivered to the target object, the overall amount of agrochemicals sprayed can be reduced, thereby improving efficiency and effectiveness and reducing the environmental impact of both the use of the agrochemicals and their fabrication and transport. The method can adapt to changes in the spray assembly and the topology of the surface being sprayed in real-time (e.g. in the time between detection of a target object and a nozzle passing over that target object), rather than requiring precise control of the spray height (i.e. the separation of nozzle and the target object).

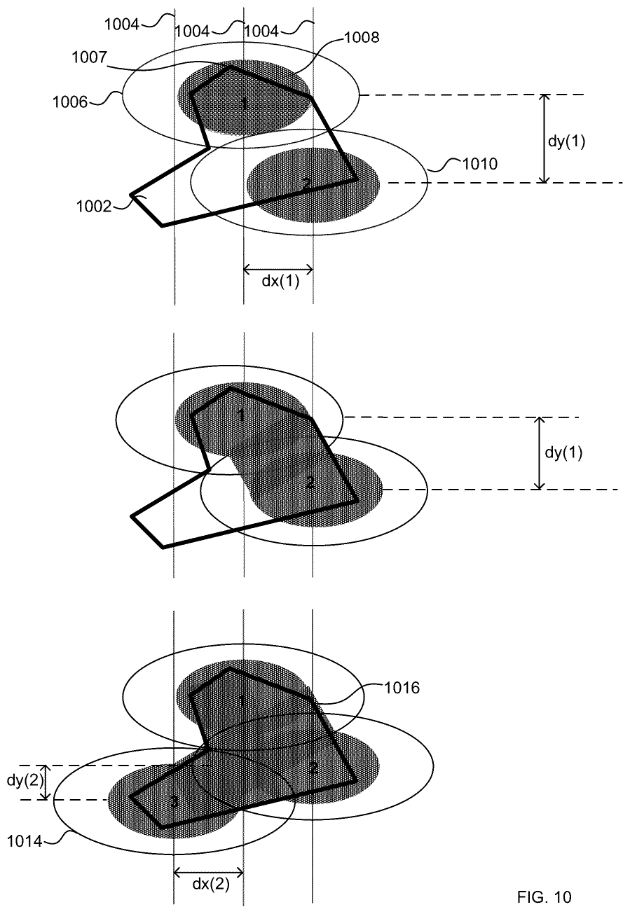

This method of FIG. 7 can be described with reference to the example shown in FIG. 10. FIG. 10 shows a shaded target object 1002 and the trajectories of three nozzles are marked by straight lines 1004. The position of a first spot spray 1006 is determined (in block 702) based on the position of the leading edge 1007 of the target object 1002. The area 1008 within the spot spray 1006 which receives at least a pre-defined minimum dose is also shown in FIG. 10 and the first spot spray 1006 is positioned so that the leading edge 1007 of the target object 1002 receives at least the pre-defined minimum dose (i.e. the leading edge 1007 falls within area 1008).

The initial position of a new adjacent spot spray 1010 is then defined (in block 704) such that the two spot sprays 1006, 1010 overlap and form a continuous spray zone that covers a portion of the target object 1002. This initial position of the new adjacent spot spray 1010 is defined in terms of offsets and in the example shown, the initial transverse offset, dx(1), is one nozzle spacing.

A dose map of the two spot sprays 1002, 1010 is calculated (in block 706) and used to determine if the resultant dose from the two spot sprays meets pre-defined criteria (in block 707). This criteria may, for example, be that the dose applied at each point on the target object 1002 exceeds the pre-defined minimum. In the example shown in FIG. 10, the combination of the first spot spray 1006 and the initial placement of the second spot spray 1010 does not meet this criteria (‘No’ in block 707) and so the placement of the second spot spray 1010 is then adjusted (in block 708). As shown in FIG. 10, the transverse offset, dx(1), which is constrained to be a multiple of the nozzle spacing, remains unchanged whereas the longitudinal offset, dy(1), is reduced so that there is a single area 1012 that receives at least the pre-defined minimum dose (instead of two separate areas, as was the case with the initial placement). The optimization of the offsets (in block 708) increases the area of the target object 1002 that receives at least the pre-defined minimum dose.

The method then proceeds to determine that the entirety of the target object 1002 is not yet fully covered by the placed spot sprays (‘No’ in block 709) and the initial position of a further spot spray 1014 is then defined (in a second iteration of block 704) such that new spot spray overlaps with the spray zone of the existing spot sprays 1006, 1010 to form a continuous spray zone that covers the target object 1002. This initial position of the new adjacent spot spray 1014 is defined in terms of offsets and as with the first spot spray, the offsets of the second spot spray 1014 may be adjusted (in block 708). The third diagram in FIG. 10 shows the final position of the newly added second spot spray 1014. The final transverse offset, dx(2) is one nozzle spacing and the final longitudinal offset, dy(2), is less than the longitudinal spacing, dy(1), between the first and second spot sprays. As shown in FIG. 10, the combined dose of the three spot sprays 1006, 1010, 1014, delivers at least the pre-defined minimum dose to the entire target object 1002 (i.e. the shaded area 1016 marking the area that receives at least the pre-defined minimum dose covers the entire target object 1002).

Having determined the positions of the three spot sprays, control signals are generated (in block 710) using the final offsets and the known speed of the spray assembly (from the motion data that is input to the method). The transverse offsets define which nozzle is used to create a spot spray, and hence which electromechanical valve receives the corresponding on signal followed by an off signal to create the particular spot spray. The longitudinal offsets are translated into temporal offsets between control signals (e.g. the time difference between a pair of on and off control signals for one spot spray and a pair of on and off control signals for a next spot spray). The control signals are output to the spray assembly to control the electromechanical valves associated with the spray nozzles.

Whilst in the example in FIG. 10, three spot sprays are required to cover the target object fully and control signals are generated at this point (in block 710), depending upon the size of the target object a different number of spot sprays may be required (e.g. two or more spot sprays) and the control signals may be generated (in block 710) only after determining the positions of all required spot sprays.

In some examples, the same static 2D liquid spatial distribution may be used irrespective of the distance between the spray bar 112 and the target object, as determined by the distance detection unit 108. In other examples, the static 2D liquid spatial distribution that is used in some or all of the steps of the method of FIG. 7 is dependent upon the detected distance. For example, the same static 2D liquid spatial distribution may be input to the method, along with the detected distance, and the method may further comprise modifying the input static 2D liquid spatial distribution dependent upon the height when calculating the combined dose (e.g. in an analogous manner to the modification that is performed based on the forward motion of the spray assembly). In other examples, different static 2D liquid spatial distributions may be stored and used for different distances between the spray nozzles and the target object. An increased distance results in a larger (i.e. upscaled) spot spray but in a lower dose per unit area, as the sprayed volume is unchanged but is spread over a wider area. In some examples there may be a single detected distance provided by the distance detection unit 108 that is used for all nozzles (e.g. a single distance between the spray bar and the target object); however in other examples, more granular distance data may be provided, such as distance data per nozzle. Consequently, even if the same static 2D liquid spatial distribution is used for each nozzle and even if all nozzles are travelling at the same speed, the resultant 2D liquid spatial distributions may differ between nozzles (e.g. where the underlying surface is not flat and/or where the height of the target object differs).

As described above, the opening duration of the nozzles affects the spreading of 2D liquid spatial distribution when the spray assembly is moving. In the methods described above, it is assumed that the opening duration is fixed and is the same for all nozzles and all spot sprays. In a variation of the methods described above, the opening duration of the nozzles may be controlled by the spray control system in order to maintain a constant resultant 2D liquid spatial distribution in response to varying forward speed of the nozzles. The variations in forward speed may, for example, be a consequence of rotation of the spray assembly and/or changes in the forward speed of the spray assembly.

Instead of changing the opening duration to maintain a constant resultant 2D liquid spatial distribution in response to variations in forward speed, the opening duration of nozzles may be modified as well as the offsets (in block 708) in order to further optimize the received dose, e.g. to maintain the dose at all points within the pre-defined minimum dose and a pre-defined maximum dose and/or to reduce the overall dose whilst ensuring that all points of the target object receive at least the pre-defined minimum dose.

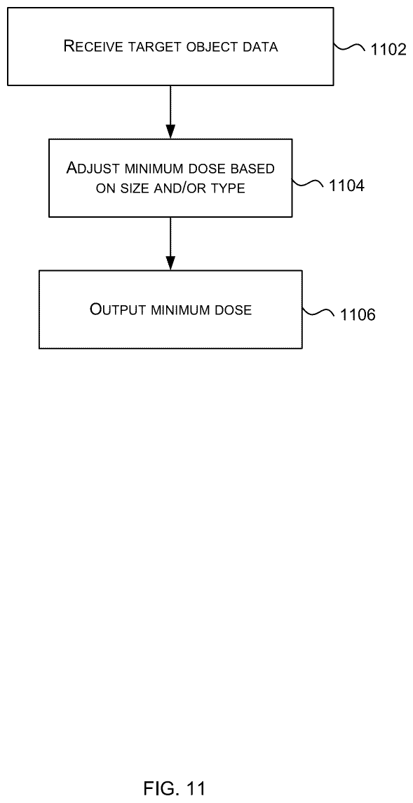

As described above, the pre-defined minimum dose that is used may be fixed or variable and may be provided as an input to the method (e.g. as shown in FIG. 7). In some examples, the spot spray control system 102 may determine the pre-defined minimum dose that is used by the method of FIG. 7 based on data received from the imaging system 106. Alternatively, this determination may be performed by the imaging system 106 and the result input to the spot spray control system 102. As shown in FIG. 11, target object data is received (block 1102). Where the method is performed by the spot spray control system 102, this data is received from the imaging system 106. Based on the data received, a pre-defined minimum dose may either be adjusted or selected from a plurality of candidate pre-defined minimum doses, based on the size of the target object and/or the type of the target object (block 1104). The resulting minimum dose is then output (block 1106) for use in the methods described above (e.g. as shown in FIG. 7).

The minimum dose may be increased (in block 1104) for larger target objects, where the size of a target object may refer to its area and/or its height (i.e. how tall it is). In addition, or instead, the minimum dose may be dependent upon the type of plant that is the target object.

By adjusting the minimum dose based on the size and/or type, the dose applied to target objects is tailored to the particular target object being sprayed and the overall effectiveness and/or efficiency of the application of agrochemicals can be increased. Additionally, this can also reduce the dose that reaches an adjacent crop plant and therefore reduce phytotoxicity for this plant where the agrochemical being applied is a herbicide.

Whilst the method of FIG. 11 refers to the modification of the pre-defined minimum dose, a similar method may be used to define or modify the pre-defined maximum dose where this is used as one of the criteria in block 707 and/or block 708.

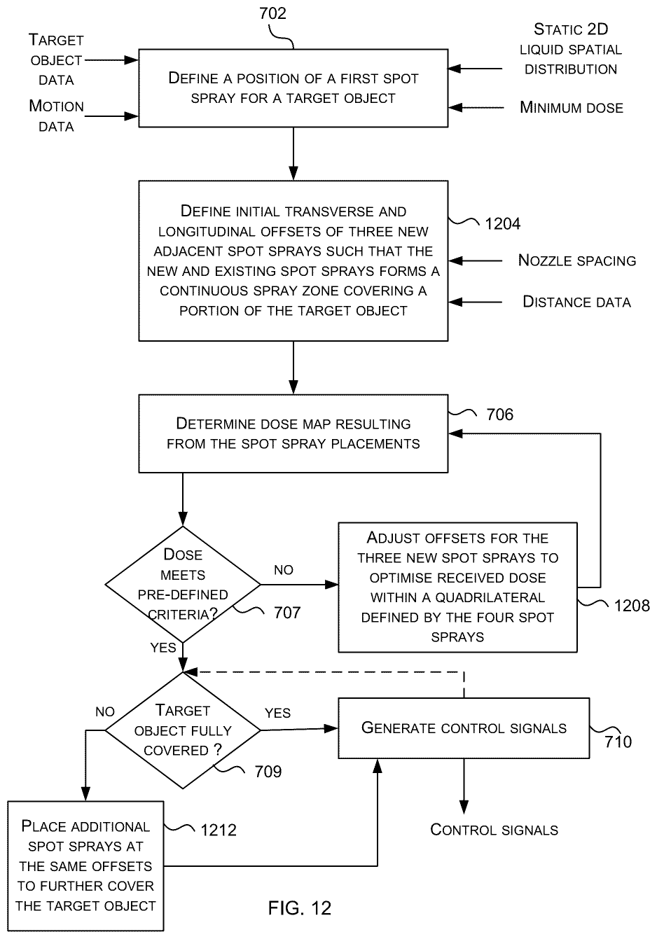

In the methods described above, the adjusted offsets that are determined (in block 708) and then used to generate control signals (in block 710) are not determined according to any pattern but based on the dose map (as calculated in block 708). FIG. 12 shows a second example method of operation of spot spray control system, such as the spot spray control system 102 shown in FIG. 1, which uses a repeating pattern for target objects that cannot be covered by four adjacent spot sprays. The method shown in FIG. 12 is a variation of the methods described above and shown in FIG. 7. The method of FIG. 12 may be used for target objects of any size (e.g. including those that are smaller than the spray zone of four spot sprays) but is particularly suited to large target objects (e.g. that require more than five spot sprays, up to tens or hundreds of spot sprays, to cover them).

As shown in FIG. 12, the method starts in the same way as FIG. 7; however, having defined the position of the first spot (in block 702), the initial position of three new adjacent spot sprays is defined (block 1204). As will be described below, lines connecting the centres of the first spot spray and the three new spot sprays define a quadrilateral (e.g. a square, rectangle or rhombus).

The method continues in the same way as FIG. 7 and if the dose from the initial placement of the four spots (the first spot and the additional three spots) does not meet pre-defined criteria (‘No’ in block 707), the offsets of the additional three spots are adjusted to optimize the received dose within the quadrilateral defined by the centre points of the four spots (block 1208). The pre-defined criteria used in block 707 may be the same as described above with reference to FIG. 7 or may be modified to relate to the quadrilateral rather than the target object, for example, that the dose applied at each point on the quadrilateral exceeds the pre-defined minimum or that the dose applied at each point on the quadrilateral is between the pre-defined minimum and a pre-defined maximum. Example optimization criteria that may be used in block 1208 may include one or more of the following: (i) the dose applied at each point in the quadrilateral exceeds the pre-defined minimum, (ii) the dose applied at each point in the quadrilateral is between the pre-defined minimum and a pre-defined maximum, (iii) the difference in received dose across the quadrilateral is reduced, (iv) the received dose across the quadrilateral is reduced whilst ensuring that it exceeds the pre-defined minimum at all points on the quadrilateral and (v) the dose at any point of the quadrilateral does not exceed a pre-defined maximum dose. As before, the transverse offset is always a multiple of the nozzle spacing, or effective nozzle spacing, hence this places a restriction on how the transverse offset can be adjusted whereas there is more flexibility to adjust the longitudinal offset.

Once the dose from the initial placement of the four spots (the first spot and the additional three spots) does meets the pre-defined criteria (‘Yes’ in block 707), it is determined whether the target object is fully covered (block 709) and if it is not fully covered, additional spot sprays are placed at the same offsets as the initial three new adjacent spot sprays to further cover the target object (block 1212).

For target objects that do not extend beyond a threshold distance in a longitudinal direction, the control signals may be generated (in block 710) once the entirety of the target object has been covered (i.e. such the additional spots placed in block 1212 cover the entire target object before progressing to block 710). For target objects that extend beyond the threshold distance in the longitudinal direction, the control signals to form the spot sprays already placed (in blocks 702, 1204 and 1212) may be generated (in block 710) before the entirety of the target object has covered (as indicated by the dotted line from block 710 to block 709). In such an example, the additional spot sprays placed in block 1212 do not cover the entirety of the target object but only a part of the target object and the control signals for these placed spot sprays (from blocks 702, 1204 and 1212) are generated (in block 710) before further additional spot sprays are placed (in block 1212) to increase the cover of the target object. The method may iterate around the loop comprising blocks 709, 1212 and 710 until the target object is fully covered (‘Yes’ in block 709) and the control signals for all spot sprays have been generated (in block 710). The threshold distance may be defined based on the field of view in the longitudinal direction of the imaging system 102. For example, the threshold distance may be set equal to the longitudinal extent of the portion of the field 210 that can be imaged by the imaging system 202 (as shown in FIG. 2).

As described above, the longitudinal spacing of spot sprays is converted into a temporal spacing when generating the control signals (in block 710) based on the known speed of the spray assembly (as received in the motion data that is input to the method). The transverse offsets define which electromechanical valve receives the pair of on and off control signals to form a spot spray, with the opening duration corresponding to the spacing between the on control signal and the off control signal in a pair of on and off control signals.

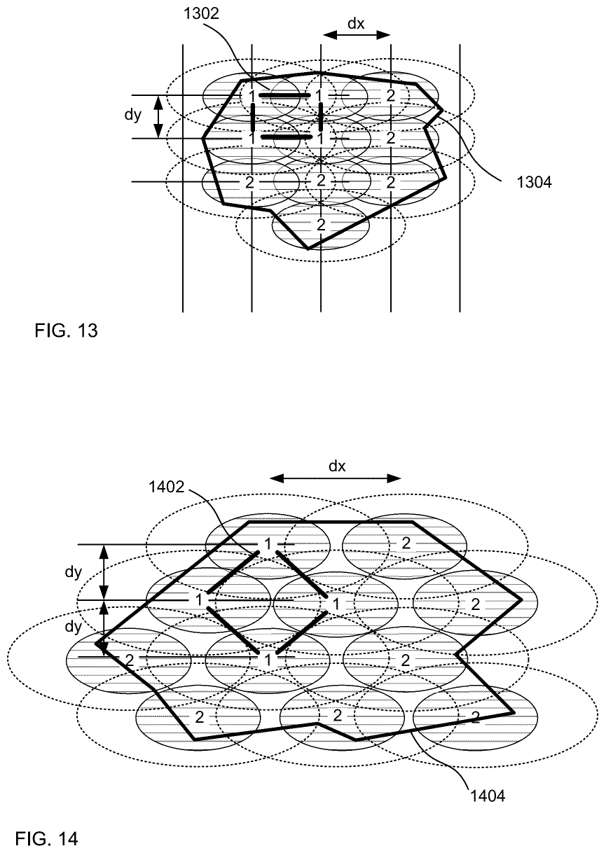

The method of FIG. 12 can be further described with reference to the examples shown in FIGS. 13 and 14. In the example shown in FIG. 13, the initial four spots that are placed (in blocks 702 and 1204) are labelled ‘1’ and the quadrilateral 1302 that is formed from lines that connect their centres is shown. In this example, the transverse spacing, dx, is equal to the nozzle spacing and as a result the quadrilateral is a rectangle or square. When adjusting the offsets (in block 1208) to optimise the received dose within the quadrilateral 1302 (e.g. to ensure that is falls between the pre-defined minimum and maximum at all points within the quadrilateral 1302), the only real freedom is in the longitudinal direction (i.e. adjusting dy) since the transverse spacing is restricted to being a multiple of the nozzle spacing. Having adjusted the offsets, the resultant offsets dx, dy, are used to place additional spot sprays (labelled ‘2’) so that the whole of the target object 1304 receives at least the pre-defined minimum dose (in block 1212).

In the example shown in FIG. 14, the initial four spots that are placed (in blocks 702 and 1204) are labelled ‘1’ and the quadrilateral 1402 that is formed from lines that connect their centres is shown. In this example, the transverse spacing, dx, is equal to twice the nozzle spacing and as a result the quadrilateral is a rhombus. When adjusting the offsets (in block 1208) to optimise the received dose within the quadrilateral 1402 (e.g. to ensure that is falls between the pre-defined minimum and maximum at all points within the quadrilateral 1302), the only real freedom is in the longitudinal direction (i.e. adjusting dy) since the transverse spacing is restricted to being a multiple of the nozzle spacing. As shown in FIG. 14, the initial four spot sprays involve two longitudinal offsets, dy; however, these offsets are the same and when performing the adjustment (in block 1208), they remain the same. Having adjusted the offsets, the resultant offsets dx, dy, are used to place additional spot sprays (labelled ‘2’) so that the whole of the target object 1404 receives at least the pre-defined minimum dose (in block 1212).

By using a repeating pattern for larger target objects, as shown in FIGS. 12-14, the computational effort in calculating the control signals is reduced and, as described above, this is advantageous because the time available to generate the control signals is very limited.

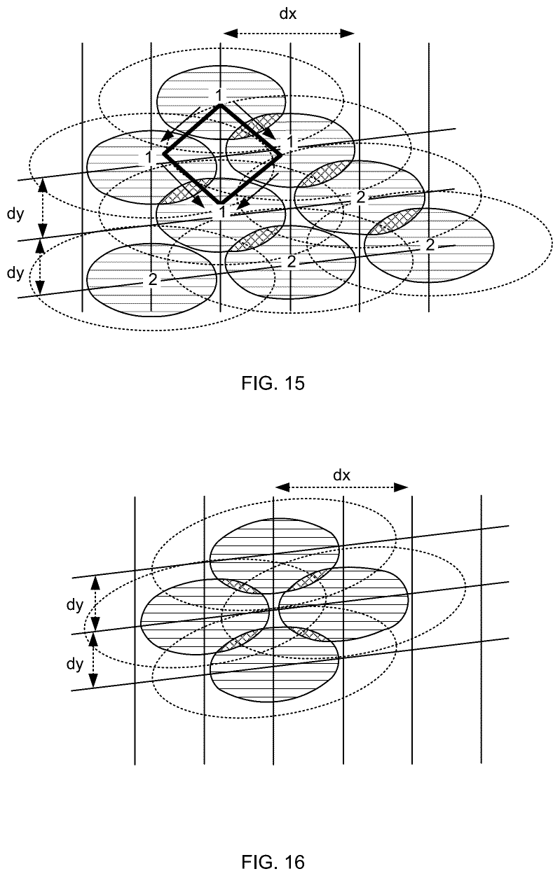

FIGS. 15 and 16 show two variations on the arrangement shown in FIG. 14. The spot sprays are placed in FIGS. 15 and 16 using the method of FIG. 12; however, the rows of spot sprays are not aligned perpendicularly to the forward direction but are at a small angle off from perpendicular. This means that the opening of the nozzles happens at different times (i.e. as they are not aligned in the forward direction) and this results in less demanding pressure regulation within the spray system. In the example shown in FIG. 15, the orientation of the nozzles is such that each individual spot spray has an elliptical shape with a minor axis that is aligned with the forward direction and this results in a non-symmetrical pattern of spot sprays. In contrast, in the example shown in FIG. 16, the orientation of the spot sprays is also tilted by the same angle (e.g. rotated along the vertical axis by around 10°) so that the major axes of the spot sprays in a row are aligned. This results in a symmetrical pattern of spot sprays.

In a variation of the methods described above, in addition to adjusting the offsets (in blocks 708 and 1208), the opening duration of the nozzles may be adjusted (e.g. to satisfy one or more of the criteria (i)-(vii) described above with reference to FIG. 7 or one or more of the criteria (i)-(v) described above with reference to FIG. 12). As described above with reference to FIG. 8, adjusting the opening duration of a valve, and hence a nozzle, changes the static 2D liquid spatial distribution and results in both an increased dose and increased spreading in the longitudinal direction when calculating the resultant 2D liquid spatial distribution (that includes the effect of the motion of the spray assembly).

In a further variation of the methods described above, in addition to adjusting the offsets (in blocks 708 and 1208) and in addition to or instead of adjusting the opening duration, the distance between the nozzles and the target object may be adjusted (e.g. to satisfy one or more of the criteria (i)-(vii) described above with reference to FIG. 7 or one or more of the criteria (i)-(v) described above with reference to FIG. 12). Adjusting the distance between the nozzle and the target object changes the static 2D liquid spatial distribution (as there is increased spreading in both the longitudinal and transverse directions).

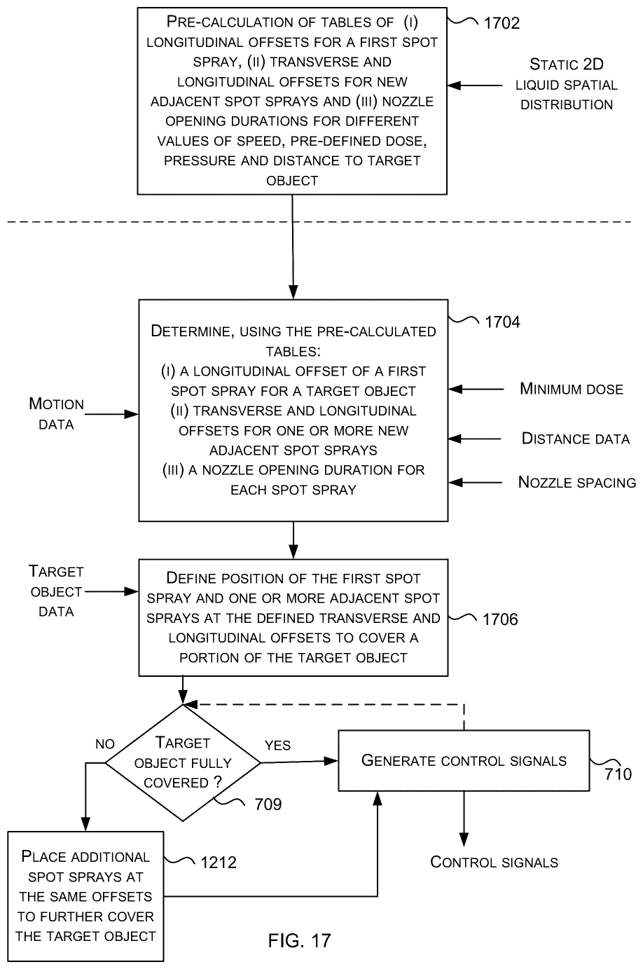

In the methods described above, the offsets are determined and adjusted dynamically during the spray operation (i.e. as the field is being scanned by the imaging system). FIG. 17 shows a third example method of operation of spot spray control system, such as the spot spray control system 102 shown in FIG. 1, which uses a repeating pattern for target objects (as in the method of FIG. 12), but where the offsets that are used are selected from a set of pre-calculated tables. These tables are generated in advance of the spray operation and may be used for many spray operations. Memory is required to store these tables, although this memory may be remote from the spot spray control system 102 (e.g. it may be stored in a remote data center) but the use of pre-calculated tables eliminates the computation required during the spray operation and enables the spot sprays to be positioned more quickly. The method shown in FIG. 17 is a variation of the methods described above and shown in FIGS. 7 and 12. The method of FIG. 17 may be used for target objects of any size.

As shown in FIG. 17, the pre-calculation defines tables of longitudinal offsets for a first spot spray and transverse and longitudinal offsets for new adjacent spot sprays along with the opening duration for each spot spray for different values of one or more of the following parameters: speed, dose requirements (e.g. minimum and/or maximum dose), pressure and distance between the nozzle and the target object (block 1702). Within each set of pre-calculated values comprising (i) a longitudinal offset for the first spot spray, (iii) the transverse and longitudinal offsets for one or more new adjacent spot sprays and (iii) the nozzle opening duration for each spot spray, the nozzle opening duration may be the same for each spot spray or may differ between spot sprays (e.g. such that a separate opening duration is defined for each spot spray). This pre-calculation (in block 1702) is performed in advance of the spray operation and the data is then used for subsequent spray operations and so the pre-calculation may be described as being performed offline. As shown in FIG. 17 the pre-calculation may receive as an input the static 2D liquid spatial distribution of a nozzle which, as described above, may itself be defined in terms of a look-up table. In some examples, different tables (or different sets of tables) may be pre-calculated for different nozzles with different static 2D liquid spatial distributions.

At spray time, the offsets for a first spot spray and one or more new adjacent spot sprays along with the corresponding nozzle opening duration for each spot spray are determined using the pre-calculated tables (block 1704). This determination comprises looking up the offsets and nozzle durations in the plurality of pre-calculated tables that correspond to the current speed (as indicated in the motion data), pre-defined minimum dose, pressure and distance and optionally nozzle type (where the pre-calculated tables include different tables for different nozzles).

Having obtained the offsets (in block 1704), the positions of the first spot sprays and new adjacent spot sprays are defined (block 1706). The lateral position of the first spot spray is defined in the same way as described above (in block 702) and the longitudinal is position is set at a point that is offset from the leading edge of the target object in the direction of forward travel by the defined longitudinal offset from the pre-calculated table. The positions of the new adjacent spot sprays are defined relative to the first spot spray using the transverse and longitudinal offsets as described above (in block 1204).

The method then continues in the same way as the method of FIG. 12. Once the positions of the first spot spray and one or more adjacent spot sprays have been determined (in block 1706, it is determined whether the target object is fully covered (block 709) and if it is not fully covered, additional spot sprays are placed at the same offsets as the one or more new adjacent spot sprays to further cover the target object (block 1212).

For target objects that do not extend beyond a threshold distance in a longitudinal direction, the control signals may be generated (in block 710) once the entirety of the target object has been covered (i.e. such the additional spots placed in block 1212 cover the entire target object before progressing to block 710). For target objects that extend beyond the threshold distance in the longitudinal direction, the control signals to form the spot sprays already placed (in block 1706 and 1212) may be generated (in block 710) before the entirety of the target object has covered (as indicated by the dotted line from block 710 to block 709). In such an example, the additional spot sprays placed in block 1212 do not cover the entirety of the target object but only a part of the target object and the control signals for these placed spot sprays (from blocks 1706 and 1212) are generated (in block 710) before further additional spot sprays are placed (in block 1212) to increase the cover of the target object. The method may iterate around the loop comprising blocks 709, 1212 and 710 until the target object is fully covered (‘Yes’ in block 709) and the control signals for all spot sprays have been generated (in block 710). The threshold distance may be defined based on the field of view in the longitudinal direction of the imaging system 102. For example, the threshold distance may be set equal to the longitudinal extent of the portion of the field 210 that can be imaged by the imaging system 202 (as shown in FIG. 2).

As described above, the longitudinal spacing of spot sprays is converted into a temporal spacing when generating the control signals (in block 710) based on the known speed of the spray assembly (as received in the motion data that is input to the method). The transverse offsets define which electromechanical valve receives the pair of on and off control signals to form a spot spray, with the opening duration (as determined in block 1704) corresponding to the temporal spacing between the on control signal and the off control signal in a pair of on and off control signals.

The results of the method of FIG. 17 in terms of spot spray placement, and hence control signals that are generated, is the same as for the method of FIG. 12; however, instead of adjusting offsets during the spray process, the data is pre-calculated and looked up based on actual dynamic variables of the spray process (e.g. motion data, pre-defined minimum dose, distance, etc.).

In the methods described above, many of the criteria involve ensuring that all parts of the target object receive at least a pre-defined minimum dose. In a variation of the methods described above, the criteria may be modified so that at least a minimum proportion of the target object (e.g. at least 90% of the target object) receives the pre-defined minimum dose. Where both a pre-defined minimum and pre-defined maximum are used, the pre-defined maximum must not be exceeded at any point within the spray zone, even if this as the effect that a small part of the target object receives less than the pre-defined minimum.

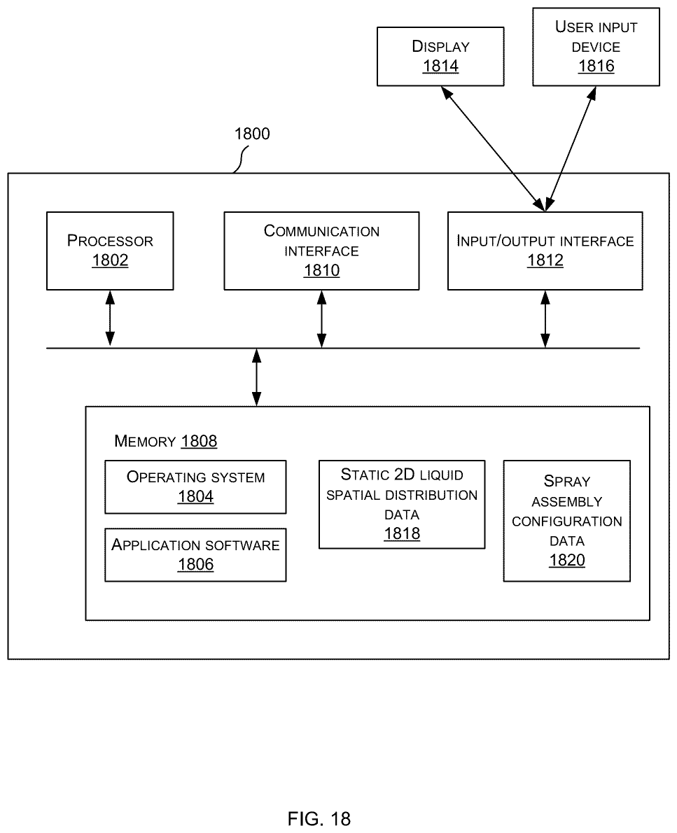

The methods described above may be implemented by a spot spray control system, such as the spot spray control system 102 shown in FIG. 1. The spot spray control system may be implemented by one or more processors. The one or more processors can be programmable (e.g., a central processing unit (CPU) or a microcontroller), a field programmable gate array (FPGA), DSP, ASICs, PLC and/or one or more ARM processors, etc. FIG. 18 illustrates various components of an example spot spray control system in the form of a computing-based device 1800. As described above, this computing-based device may also perform some of the functionality of the distance detection unit 108 and imaging system 106 shown in FIG. 1.

Computing-based device 1800 comprises one or more processors 1802 which may be microprocessors, controllers or any other suitable type of processors for processing computer executable instructions to control the operation of the device in order to perform the methods described herein (e.g. as shown in FIGS. 7, 12 and 17). In some examples, for example where a system on a chip architecture is used, the processors 1802 may include one or more fixed function blocks (also referred to as accelerators) which implement a part of the method of controlling a spot spray system in hardware (rather than software or firmware). Platform software comprising an operating system 1804 or any other suitable platform software may be provided at the computing-based device to enable application software 1806, such as software that implements the methods described herein, to be executed on the device.

The computer executable instructions may be provided using any computer-readable media that is accessible by computing-based device 1800. Computer-readable media may include, for example, computer storage media such as memory 1808 and communications media. Computer storage media, such as memory 1808, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 1808) is shown within the computing-based device 1800 it will be appreciated that the storage may be distributed or located remotely and accessed via a network or other communication link (e.g. using communication interface 1810).

The communication interface 1810 may be arranged to receive data used in the methods described herein such as motion data (e.g. from vehicle 206 shown in FIG. 2 or from a sensor within the spot spray system), target object data (e.g. from the imaging system 106) and height data (e.g. from the distance detection unit 108). The communication interface 1810 may also be arranged out output the generated control signals (e.g. to the electromechanical valves 114 in the spray assembly 104).

The computing-based device 1800 may also comprises an input/output interface 1812 arranged to output display information to a display device 1814 which may be separate from or integral to the computing-based device 1800. For example, a display device 1814 may be attached to the body 204 of the spot spraying system 200 shown in FIG. 2 or positioned in the vehicle 206. In addition, or instead, the display information may be output via the communication interface 1810 to a remote display device 1814 (in a monitoring location that is remote from the spot spray system). The display information may provide a graphical user interface. The input/output interface 1812 may also be arranged to receive and process input from one or more devices, such as a user input device 1816 (e.g. one or more buttons on the body 204 of the spot spraying system 200 shown in FIG. 2 or positioned in the vehicle 206). This user input may be used to adjust parameters of the method or provide inputs, such as the pre-defined minimum dose. In an embodiment the display device 1814 may also act as the user input device 1816 if it is a touch sensitive display device. In some examples the input/output interface 1812 may be arranged to output the generated control signals (e.g. to the electromechanical valves 114 in the spray assembly 104) instead of, or in addition to, the communication interface 1810.

The memory 1808 may be arranged to store data used by the methods described herein, such as the static 2D liquid spatial distributions 1818 and configuration data for the spray assembly 1820 (e.g. nozzle spacing). Where the method of FIG. 17 is used, the memory 1808 may be arranged to store the pre-calculated tables.

Whilst FIG. 18 shows a single computing device that may be implemented locally within the spot spray system 100, 200 shown in FIGS. 1 and 2, in other examples some of the processing and/or data storage may be implemented remotely from the spray assembly, e.g. on a remote computing device that may be located in a data center or elsewhere. For example, the static 2D liquid spatial distributions 1818 and/or configuration data for the spray assembly 1820 may be stored remotely and accessed via the communication interface 1810. In addition or instead, the computation of the dose map (in block 706) and offset modification (in blocks 708 and 1208) may be performed by a remote computing device and the resultant modified offsets received by the spray system via the communication interface 1810. In other examples, the processing and/or data storage may be split in a different way between a local computing device proximate to the spray assembly and a remote computing device (or plurality of local computing devices, e.g. where the data processing is performed on a different computing device to the data storage).

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of operation of a spot spray control system for spraying agrochemicals using a spray assembly, the spray assembly comprising an array of nozzles and the method comprising:
(i) defining a position of a first spot spray based on a position of a leading edge of a target object (702);
(ii) defining an initial position in terms of a transverse offset and a longitudinal offset relative to the first spot spray, of at least one new adjacent spot spray (704, 1204) such that the combined dose of the first and new spot sprays forms a continuous spray zone that covers a portion of the target object, wherein each of the first and new spot sprays is defined by a non-homogenous two-dimensional liquid spatial distribution and the transverse offset is a multiple of an effective spacing of the nozzles in the array of nozzles;
(iii) determining a two-dimensional dose map resulting from the first and new spot sprays (706);
(iv) in response to determining, from the two-dimensional dose map, that pre-defined dose criteria are not met (707), adjusting the offsets of the at least one new adjacent spot spray to optimise a received dose (708, 1208);
(v) generating control signals for the array of nozzles according to the position of the first spot spray and adjusted offsets of the at least one new adjacent spot spray (710); and
(vi) outputting the control signals to the spray assembly.

2. The method according to claim 1, further comprising:
in response to determining, from the two-dimensional dose map, that the target object is not fully covered by the spray zone (709), repeating steps (ii)-(iv) until the target object is fully covered.

3. The method according to claim 1, wherein:
defining an initial position in terms of a transverse offset and a longitudinal offset relative to the first spot spray, of at least one new adjacent spot spray comprises: defining an initial position in terms of a transverse offset and a longitudinal offset relative to the first spot spray, of three new adjacent spot sprays (1204); and
adjusting the offsets of the at least one new adjacent spot spray to optimise a received dose comprises: adjusting the offsets of the three new adjacent spot sprays to optimise a received dose within a quadrilateral defined by the first spot spray and the three new adjacent spot sprays (1208).

4. The method according to claim 3, further comprising:
in response to determining, from the two-dimensional dose map, that the target object is not fully covered by the spray zone (709), placing additional spot sprays using the adjusted offsets until the target object is fully covered (1212).

5. The method of claim 1, wherein the two-dimensional liquid spatial distribution for a spot spray is determined based on a static two-dimensional liquid spatial distribution for a nozzle and received motion data for the spray assembly.

6. The method of claim 1, wherein the two-dimensional liquid spatial distribution for a spot spray is determined based on a static two-dimensional liquid spatial distribution for a nozzle and a detected distance between the array of nozzles and the target object.

7. The method of claim 1, wherein the two-dimensional liquid spatial distribution for a spot spray is determined based on a static two-dimensional liquid spatial distribution for a nozzle and an opening duration of the nozzle.

8. The method of claim 1, wherein the two-dimensional liquid spatial distribution for a spot spray is defined in a look-up table.

9. The method of claim 1, wherein the two-dimensional liquid spatial distribution for a spot spray is defined using a Gaussian or normal distribution.

10. The method of claim 1, further comprising adjusting an opening duration of a nozzle to maintain a constant two-dimensional liquid spatial distribution for a spot spray in response to changes in forward speed of the nozzle during spraying.

11. The method of claim 1, wherein the received dose is optimized by ensuring that the received dose exceeds a pre-defined minimum dose.

12. The method of claim 11, further comprising adjusting the pre-defined minimum dose based on a size or type of the target object (1104).

13. The method of claim 1, wherein the received dose is optimized by ensuring that the received dose does not exceed a pre-defined maximum dose.

14. A computer program comprising instructions which, when the program is executed by a computer, cause the computer to carry out the method of claim 1.

15. A computer-readable medium having stored thereon the computer program of claim 14.

16. A spot spray control system for spraying agrochemicals using a spray assembly, the spray assembly comprising an array of nozzles and the spot spray control system comprising:
a processor (1802);
one or more interfaces (1810, 1812) configured to receive target object data and output control signals to the spray assembly; and
memory (1808) arranged to store a computer program which, when executed by the processor, causes the control system to:
(i) define a position of a first spot spray based on a position of a leading edge of a target object (702);
(ii) define an initial position in terms of a transverse offset and a longitudinal offset relative to the first spot spray, of at least one new adjacent spot spray (704, 1204) such that the combined dose of the first and new spot sprays forms a continuous spray zone that covers a portion of the target object, wherein each of the first and new spot sprays is defined by a non-homogenous two-dimensional liquid spatial distribution and the transverse offset is a multiple of an effective spacing of the nozzles in the array of nozzles;
(iii) determine a two-dimensional dose map resulting from the first and new spot sprays (706);
(iv) in response to determining, from the two-dimensional dose map, that pre-defined dose criteria are not met (707), adjust the offsets of the at least one new adjacent spot spray to optimise a received dose (708, 1208);
(v) generate control signals for the array of nozzles according to the position of the first spot spray and adjusted offsets of the at least one new adjacent spot spray (710); and
(vi) output the control signals to the spray assembly via the one or more interfaces.

17. A method of operation of a spot spray control system for spraying agrochemicals using a spray assembly, the spray assembly comprising an array of nozzles and the method comprising:
determining, using pre-calculated tables, a longitudinal offset of a first spot spray, transverse and longitudinal offsets for one or more new adjacent spot sprays (1704), and a nozzle opening duration of each spot spray, wherein each of the first and new spot sprays is defined by a non-homogenous two-dimensional liquid spatial distribution and the transverse offset is a multiple of an effective spacing of the nozzles in the array of nozzles;
defining a position of the first spot spray based on a position of a leading edge of a target object and the determined longitudinal offset of the first spot spray;
defining positions of the one or more new adjacent spot sprays relative to the position of the first spot spray based on the determined transverse and longitudinal offsets for the one or more new adjacent spot sprays (1706);
generating control signals for the array of nozzles according to the position of the first spot spray and the one or more new adjacent spot sprays, the opening duration for each spot spray and a displacement speed of the nozzles (710); and
outputting the control signals to the spray assembly.

18. The method according to claim 17, wherein determining, using pre-calculated tables, a longitudinal offset of a first spot spray, transverse and longitudinal offsets for one or more new adjacent spot sprays and a nozzle opening duration for each spot spray comprises:
performing a look up in the pre-calculated tables for the longitudinal offset of the first spot spray, the transverse and longitudinal offsets for one or more new adjacent spot sprays and the nozzle opening duration for each spot spray, wherein the look up is based on a speed of the array of nozzles, a pre-defined minimum dose and an input distance between the nozzles and the target object.

19. The method of claim 18, further comprising:
in response to determining that the target object is not fully covered by the first and new spot sprays (709), placing additional spot sprays using the determined transverse and longitudinal offsets until the target object is fully covered (1212).

20. The method of claim 19, further comprising:
pre-calculating the tables of offsets and nozzle opening durations, the tables comprising a longitudinal offset of a first spot spray, transverse and longitudinal offsets for one or more new adjacent spot sprays, and nozzle opening durations of each spot spray for different values of speed, pre-defined dose, pressure and distance to the target object (1702).

21. A computer program comprising instructions which, when the program is executed by a computer, cause the computer to carry out the method of claim 17.

22. A computer-readable medium having stored thereon the computer program of claim 21.

23. A spot spray control system for spraying agrochemicals using a spray assembly, the spray assembly comprising an array of nozzles and the spot spray control system comprising:
a processor (1802);
one or more interfaces (1810, 1812) configured to receive target object data and output control signals to the spray assembly; and
memory (1808) arranged to store a computer program which, when executed by the processor, causes the control system to:
determine, using pre-calculated tables, a longitudinal offset of a first spot spray, transverse and longitudinal offsets for one or more new adjacent spot sprays (1704), and a nozzle opening duration for each spot spray, wherein each of the first and new spot sprays is defined by a non-homogenous two-dimensional liquid spatial distribution and the transverse offset is a multiple of an effective spacing of the nozzles in the array of nozzles;
define a position of the first spot spray based on a position of a leading edge of a target object and the determined longitudinal offset of the first spot spray;
define positions of the one or more new adjacent spot sprays relative to the position of the first spot spray based on the determined transverse and longitudinal offsets for the one or more new adjacent spot sprays (1706);
generate control signals for the array of nozzles according to the position of the first spot spray and the one or more new adjacent spot sprays, the opening duration for each spot spray and a displacement speed of the nozzles (710); and
output the control signals to the spray assembly via the one or more interfaces.
